(19) United States
(12) Patent Application Publication
(10) Pub. No.: US 2009/0004521 A1
(43) Pub. Date: Jan. 1, 2009

(54) ALKALINE FUEL CELL

(75) Inventors: Akira Morita, Tokyo (JP); Shoji Ihara, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/136,358

(22) Filed: Jun. 10, 2008

(30) Foreign Application Priority Data
Jun. 27, 2007 (JP) 2007-168570

(51) Int. Cl. H01M 8/04; H01M 8/10

(52) U.S. Cl. 429/26; 429/30

(57) ABSTRACT

An alkaline fuel cell, which can humidify an oxidizer depending on the temperature of a power generation part and which is small in size and is produced at a low cost. The alkaline fuel cell includes a power generation part having an anion exchange membrane disposed between a fuel electrode to which a fuel solution containing a fuel component and a water component is supplied and an oxidizer electrode to which an oxidizer is supplied, and a heating/humidifying part for heating and humidifying the oxidizer to be supplied to the oxidizer electrode. The heating/humidifying part has a water-permeable membrane for separating the oxidizer and the fuel solution such that heat and a water component of the fuel solution are transportable to the oxidizer through the water-permeable membrane.

### BACKGROUND OF THE INVENTION

1. Field of the Invention

The present invention relates to an alkaline fuel cell.

2. Description of the Related Art

There are various types of fuel cells. In an alkaline fuel cell, which includes an anion exchange membrane as an electrolyte membrane, a noble metal need not be used as a catalyst because the inside of this fuel cell does not have a strong acidic environment, unlike a fuel cell, which includes a cation exchange membrane as an electrolyte membrane.

Furthermore, because components of an alkaline fuel cell, such as a separator, do not need to be strongly acid-resistant, low-cost materials can be used.

Therefore, for the alkaline fuel cell, it is expected that the production cost can be greatly reduced and that the power generation performance of the fuel cell can be improved by using a metal catalyst other than a noble metal as an oxidation-reduction catalyst for the fuel cell.

When ethanol is used as a fuel, the electrode reaction of the alkaline fuel cell is as follows:

Fuel Electrode: C₂H₅OH+12OH⁻→2CO₂+9H₂O+12e⁻ (1)

Oxidizer Electrode: 12e⁻+3O₂+6H₂O→12OH⁻ (2)

The anion exchange membrane used in the alkaline fuel cell is an electrolyte membrane, which allows permeation of OH ions.

During the power generation of the alkaline fuel cell, as shown by the above reaction formulae, OH ions are generated by the reaction of electrons, oxygen, and water, move to the fuel electrode through the anion exchange membrane, and react with ethanol on the fuel electrode side to generate carbon dioxide, water, and electrons.

In an alkaline fuel cell including an anion exchange membrane, water is required for the power generation reaction. Therefore, in general, a predetermined amount of water is added to a fuel in advance and the resulting fuel solution is used for a power generation reaction, whereby the fuel and water are supplied at the same time.

In a fuel cell that has a cation exchange membrane, in an electrode reaction during power generation, hydrogen ions move from a fuel electrode to an oxidizer electrode through the cation exchange membrane and water is generated from hydrogen ions, electrons, and oxygen on the oxidizer electrode side. On the other hand, in the alkaline fuel cell, water is generated on the fuel electrode side.

In the alkaline fuel cell, water is consumed in the oxidizer electrode at the time of the power generation reaction.

Although water is supplied from the fuel electrode side to the oxidizer electrode side through the anion exchange membrane, when an oxidizer to be supplied to the oxidizer electrode is dry, there is a problem in that the water diffuses into the oxidizer and water necessary for the power generation reaction is not sufficiently supplied, whereby the output is reduced.

In the fuel cell, since the temperature of a reaction part becomes higher than room temperature during power generation, when atmospheric air is supplied as an oxidizer, the relative humidity of the reaction part greatly decreases to dry the air.

There has not yet been reported any technology for an alkaline fuel cell that solves the above-mentioned problem.

When hydrogen is used as a fuel in a cation exchange membrane fuel cell, although water is not required as a reactant, the cation exchange membrane needs to be humidified to maintain a high electric conductivity depending on the type of the cation exchange membrane.

Hitherto, to humidify an electrolyte membrane in a cation exchange membrane hydrogen fuel cell, the following methods have been proposed.

Japanese Patent Application Laid-Open No. 2005-322529 proposes a method in which a humidifying water permeation plate, which has a water flow path and is made of a porous material, is disposed outside of an oxidizer electrode and water is supplied from outside of the humidifying water permeation plate.

Further, as a method of controlling the degree of humidification of an oxidizer gas, Japanese Patent Application Laid-Open No. 2005-197150 proposes forming at least part of a separator from a water-permeable porous part and providing a cooling gas flow path on a side opposite to an oxidizer gas flow path.

With the above-mentioned proposals, the humidity of an oxidizer gas can be controlled depending on the humidity of a cooling gas.

However, the methods proposed in Japanese Patent Application Laid-Open No. 2005-322529 and Japanese Patent Application Laid-Open No. 2005-197150 have the following problems when an oxidizer is to be humidified.

That is, in the method proposed by Japanese Patent Application Laid-Open No. 2005-322529, the water flow path needs to be provided separately to humidify the oxidizer. Also, water for flowing in the water flow path and control of water circulation are required. This makes the system large in size, complicated, and heavy.

In the method proposed in Japanese Patent Application Laid-Open No. 2005-197150, a separate gas flow path (cooling gas flow path) needs to be provided to humidify the oxidizer. Thus, the system also becomes large in size, complicated, and heavy.

Since the system becomes large in size, complicated, and heavy in the methods disclosed in Japanese Patent Application Laid-Open No. 2005-322529 and Japanese Patent Application Laid-Open No. 2005-197150, the size of a fuel cell needs to be reduced.

Further, since it is difficult to control the temperature at the time of humidifying an oxidizer depending on a temperature variation of a power generation part, humidification may become insufficient, or the temperature at the time of humidification may become too high, thereby causing dew condensation in the oxidizer flow path or on the surface of an oxidizer side electrode.

Therefore, a problem in the above-mentioned methods is that it is difficult to supply the oxidizer to the oxidizer electrode.

### SUMMARY OF THE INVENTION

The present invention is directed to an alkaline fuel cell, which can humidify an oxidizer depending on the temperature of a power generation part with a simple structure and which is small in size and reduces cost.

The present invention provides an alkaline fuel cell having the following structure. The alkaline fuel cell of the present invention includes a power generation part having an anion exchange membrane disposed between a fuel electrode to which a fuel solution containing a fuel component and a water component is supplied and an oxidizer electrode to which an oxidizer is supplied, and a heating/humidifying part for heating and humidifying the oxidizer to be supplied to the oxidizer electrode. The heating/humidifying part has a water-permeable membrane for separating the oxidizer and the fuel solution such that heat and a water component of the fuel solution are transportable to the oxidizer through the water-permeable membrane.

According to the present invention, there is provided an alkaline fuel cell, which can humidify an oxidizer depending on the temperature of a power generation part with a simple structure, is small in size, and enables a reduction in cost.

Particularly, a fuel cell can be realized that can generate a stable high-power output by humidifying an oxidizer with a water component contained in a fuel solution and supplying the humidified oxidizer to a power generation part.

Further features of the present invention will become apparent from the following description of exemplary embodiments with reference to the attached drawings.

### BRIEF DESCRIPTION OF THE DRAWINGS

FIG. 1 is a schematic view illustrating a constitutional example of an alkaline fuel cell according to Embodiment 1 of the present invention.

FIGS. 2A, 2B, and 2C are schematic views illustrating the structures of a power generation part and a heating/humidifying part of the alkaline fuel cell according to Embodiment 1 of the present invention.

FIG. 3 is a schematic view illustrating the humidification of an oxidizer by the heating/humidifying part in the alkaline fuel cell according to Embodiment 1 of the present invention.

FIGS. 4A and 4B are schematic views illustrating a separator having another flow path shape of the alkaline fuel cell according to Embodiment 1 of the present invention.

FIG. 5 is a schematic view illustrating the structure of a power generation part and a heating/humidifying part of the alkaline fuel cell according to Embodiment 2 of the present invention.

FIG. 6 is a schematic view illustrating a constitutional example of a power generation part and a heating/humidifying part, which are separate units in the alkaline fuel cell according to Embodiment 3 of the present invention.

FIG. 7 is a schematic view illustrating the structure of the heating/humidifying part of the alkaline fuel cell according to Embodiment 3 of the present invention.

FIG. 8 is a schematic view illustrating a power generation part and a heating/humidifying part of the alkaline fuel cell according to Embodiment 4 of the present invention.

### DESCRIPTION OF THE EMBODIMENTS

Preferred embodiments of the present invention will now be described in detail in accordance with the accompanying drawings.

According to the present invention, there can be provided an alkaline fuel cell having a unit capable of heating an oxidizer with the heat of a fuel and humidifying the oxidizer with water contained in a fuel solution in a heating/humidifying part.

In the alkaline fuel cell of the present invention, air or oxygen may be used as the oxidizer and an alcohol, such as methanol, ethanol, or isopropanol, or an organic compound, such as dimethyl ether, may be used as the fuel in the form of a solution containing a water component. Since ethanol can be manufactured from biomass, ethanol is attracting special attention as a regenerable fuel and also as an alternative to oil energy source. A water component contained in those fuels is transported to the oxidizer in the heating/humidifying part to humidify the oxidizer.

Next, an embodiment of an alkaline fuel cell having a power generation part including an anion exchange membrane as an electrolyte membrane between a fuel electrode to which a fuel solution containing a fuel component and a water component is supplied and an oxidizer electrode to which an oxidizer is supplied in the present invention is described.

### Embodiment 1

A constitutional example of the alkaline fuel cell according to Embodiment 1 of the present invention is described below.

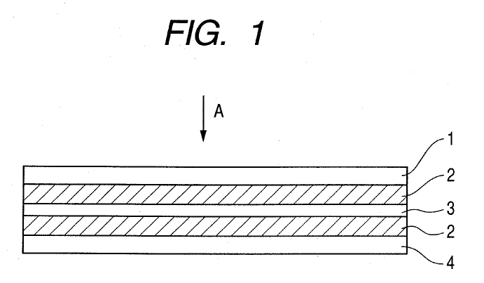

FIG. 1 is a schematic view illustrating this example.

FIG. 1 is a side view of one cell unit of the fuel cell. The fuel cell of this embodiment may be constituted of either a stack of multiple similar cell units or only one cell unit.

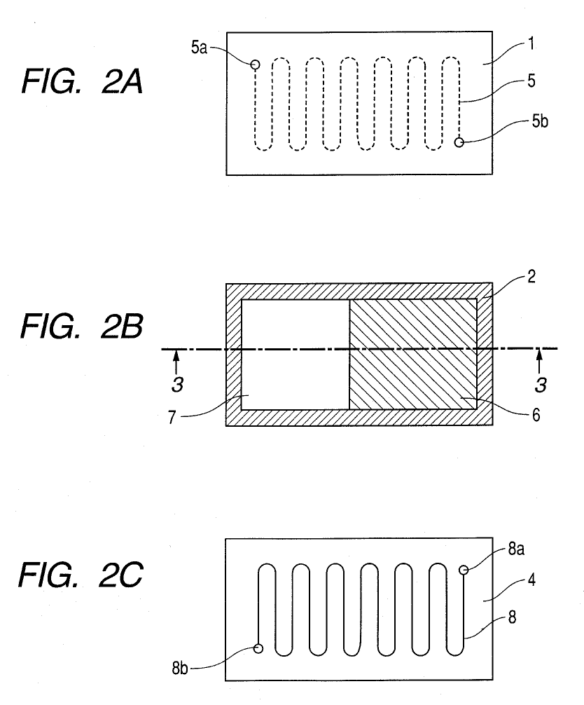

In FIG. 1, the fuel cell unit has a separator 1 (oxidizer electrode side separator), which is disposed on an oxidizer electrode side and has a flow path 5 for an oxidizer therein as will be described in FIG. 2, a gasket 2, which is disposed so as to surround a power generation part, and a heating/humidifying part as will be described in FIG. 2 and an electrolyte membrane 3, which is an anion exchange membrane capable that allows efficient permeation of anions. The electrolyte membrane has a high water affinity, but rarely allows fuel to permeate. Further, the fuel cell unit has a separator 4 (fuel electrode side separator) which is disposed on a fuel electrode side and has a flow path 8 for a fuel solution therein as will be described in FIG. 2.

The structures of the power generation part and the heating/humidifying part of the alkaline fuel cell of this embodiment are described below.

FIGS. 2A, 2B, and 2C are schematic views illustrating those structures. FIGS. 2A to 2C are views of the fuel cell unit in direction A of FIG. 1. In FIGS. 2A to 2C, the fuel cell unit has a flow path 5 formed in the oxidizer electrode side separator.

Further, the fuel cell unit has a flow path 8 for circulating a fuel, which is formed in the fuel electrode side separator.

Each of those flow paths is constituted by a groove engraved on the separator such that each of the flow paths has an opening part on the electrolyte membrane side.

In FIG. 2A, as shown by a dotted line, a flow path having an opening part is engraved on the rear side of the oxidizer electrode side separator when viewed in direction A of FIG. 1.

The oxidizer flows toward an outlet 5b from an inlet 5a along the flow path 5. The fuel solution flows toward an outlet 8b from an inlet 8a along the flow path 8.

Also, the fuel cell unit has a power generation part 6 and a heating/humidifying part 7. In this embodiment, the heating/humidifying part is composed of an oxidizer electrode side space and a fuel electrode side space that are opposite to each other with the electrolyte membrane interposed therebetween in a partial area of the electrolyte membrane.

At that time, the above oxidizer electrode side space in the partial area of the electrolyte membrane is formed by being surrounded by the electrolyte membrane, the separator, and the gasket arranged on the oxidizer electrode side.

In addition, the above fuel electrode side space in the partial area of the electrolyte membrane is formed by being surrounded by the electrolyte membrane, the separator, and the gasket arranged on the fuel electrode side.

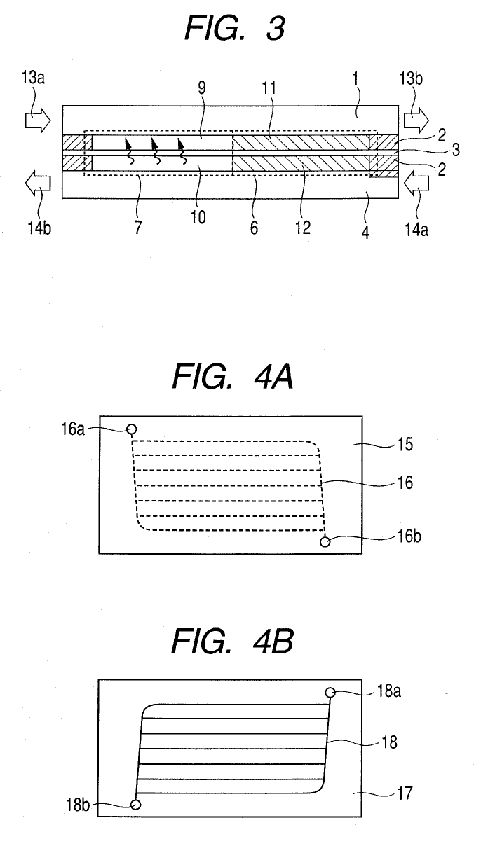

FIG. 3 is a schematic view illustrating the humidification of the oxidizer by the above heating/humidifying part.

FIG. 3 is a cross-sectional view taken along line 3-3 in FIG. 2B.

In FIG. 3, the fuel cell unit has an oxidizer electrode 11, which includes an oxidizer electrode catalyst, a binder, and a gas diffusion layer, and a fuel electrode 12, which includes a fuel electrode catalyst, a binder, and a gas diffusion layer.

The power generation part 6 is composed of a so-called membrane electrode assembly (hereinafter, simply referred to as “MEA”), which includes a part of the electrolyte membrane 3, the oxidizer electrode 11, and the fuel electrode 12.

A noble metal-based catalyst or a non-noble metal-based catalyst may be used as the catalysts for the oxidizer electrode 11 and the fuel electrode 12, depending on the types of various fuels.

Pt and Pt—Ru may be used as the noble metal catalyst and Ni, Co, Ti, Fe—Co, and Fe—Co—Ni may be used as the non-noble metal catalyst.

Metal fine particles containing one of those elements may be used as the catalyst. Those metal fine particles may be carried on a carrier, such as carbon fine particles, before use. Although any binder can be used as long as it can fix the catalyst, a resin having anion conductivity is preferably used. The gas diffusion layer is made of a material having both electron conductivity and gas permeability. For example, carbon paper, carbon cloth, metal foam, metal mesh may be used. Depending on the circumstances, carbon fine particles, a resin, or a mixture thereof may be filled into the above materials or applied to the surface thereof.

The electrolyte membrane is formed of an anion exchange membrane. The anion exchange membrane is not particularly limited as long as it is a medium that can move OH ions generated on the oxidizer electrode side to the fuel electrode side.

The membrane is, for example, a solid polymer membrane (anion exchange resin) having anion exchange groups, such as quaternary ammonium groups or pyridinium groups.

In order to prevent the loss of energy, it is preferable that the permeability of the electrolyte membrane for an alcohol fuel be as low as possible. Stated more specifically, an electrolyte membrane having an alcohol permeability of 2.0×10⁻⁶ cm²/s or less may be used. To manufacture MEA, the above catalyst and the binder are first mixed together and stirred in a solvent, such as an alcohol, to be uniformly dispersed therein thereby preparing a slurry. The slurry is then applied to the surface of the gas diffusion layer in a predetermined thickness by using such methods as doctor blade coating, spraying, or screen printing. MEA is obtained by disposing the resulting stack on the anode side and the cathode side in such a manner that the catalyst side comes into contact with the electrolyte membrane. Alternatively, the catalyst may be applied to the surface of the electrolyte membrane and not to the surface of gas diffusion layer. Then the gas diffusion layer may be stacked on the surface of the electrolyte membrane. After being stacked, the electrolyte membrane and the gas diffusion layer may be joined together by applying heat and pressure by hot-pressing or the like.

The fuel cell unit has an oxidizer electrode side space 9, which is surrounded by the electrolyte membrane 3, the gasket 2, the oxidizer electrode side separator 1, and the oxidizer electrode 11.

The fuel cell unit also has a fuel electrode side space 10, which is surrounded by the electrolyte membrane 3, the gasket 2, the fuel electrode side separator 4, and the fuel electrode 12.

In this embodiment, the heating/humidifying part 7 includes a part of the electrolyte membrane 3 and a part interposed between the above space 9 and the space 10 as described above.

The cell unit is constituted such that the oxidizer flows from 13a toward 13b along the flow path 5 engraved on the oxidizer electrode side separator 1.

The fuel solution flows from 14a toward 14b along the flow path 8 engraved on the fuel electrode side separator 4.

A mechanism through which the oxidizer is humidified when the fuel solution and the oxidizer are supplied to generate a power in the fuel cell of this embodiment is described below.

Before the oxidizer is supplied to the power generation part 6, the oxidizer passes through the heating/humidifying part 7. The electrolyte membrane 3 of the heating/humidifying part 7 absorbs water contained in the fuel solution supplied to the fuel electrode side, and the surface on the oxidizer electrode side of the electrolyte membrane 3 contains water due to its water permeability.

Therefore, after the oxidizer absorbs water on the surface of the electrolyte membrane 3 when passing through the heating/humidifying part 7, the oxidizer is supplied to the power generation part.

On the contrary, the fuel solution passes through the heating/humidifying part 7 after passing through the power generation part 6.

By adopting this constitution, the fuel solution is heated up to a power generation reaction temperature in the power generation part 6 and thereafter reaches the heating/humidifying part 7, whereby the heating/humidifying part 7 is heated up to a temperature close to the power generation reaction temperature, and the oxidizer is humidified through the electrolyte membrane 3 by water having a temperature close to the power generation reaction temperature.

Therefore, the oxidizer will be humidified at a temperature close to the power generation reaction temperature. The temperature of the power generation part 6 varies according to the amount of generated power. However, in this embodiment, when the temperature of the power generation part 6 changes, changing the temperature of the fuel solution and the temperature of the heating/humidifying part 7.

Since the humidity (relative humidity) of the oxidizer will change depending on the temperature, the oxidizer needs to be humidified at a temperature close to the power generation reaction temperature.

As described above, it is understood that the fuel cell unit of this embodiment is configured such that the heat and water component of the fuel solution are transferable to the oxidizer through the electrolyte membrane 3, which is a water-permeable membrane in the heating/humidifying part 7.

According to this embodiment, even when the power generation reaction temperature changes, the oxidizer can be humidified under conditions corresponding to the existing power generation reaction temperature.

That is, when the oxidizer is humidified at a temperature higher than the temperature of the power generation part 6, dew condensation occurs in the power generation part 6, whereby so-called flooding may be caused.

However, in this embodiment, since the temperature of the heating/humidifying part 7 is the temperature of the fuel solution after passing through the power generation part 6, the temperature does not become higher than the temperature of the power generation part 6, and the dew condensation of the oxidizer does not occur in the power generation part 6, whereby the occurrence of flooding can be prevented.

In the alkaline fuel cell, as shown by the above formula (1), water will be generated in the fuel solution by a power generation reaction.

In the heating/humidifying part 7, since the oxidizer can be humidified with water generated in the fuel solution by the power generation reaction, the amount of water additionally supplied to the fuel solution for oxidizer humidification can be reduced as much as possible.

In this embodiment, the shape of the flow path engraved on the separator is not limited to the shapes of the above flow path 5 and the flow path 8. As long as the oxidizer is sequentially supplied from the heating/humidifying part 7 to the power generation part 6 and the fuel solution is sequentially supplied from the power generation part 6 to the heating/humidifying part 7, the flow paths may have any other shape.

Further, as long as the oxidizer and the fuel solution flow in the above directions in the end, the separators may not have a flow path.

FIGS. 4A and 4B illustrate the constitutional examples of separators having a flow path with a different shape from the above flow path 5 and the flow path 8.

In FIGS. 4A and 4B, the fuel cell unit has an oxidizer electrode side separator 15 and a fuel electrode side separator 17.

The fuel cell unit has a flow path 16 formed in the oxidizer electrode side separator 15 and a flow path 18 formed in the fuel electrode side separator 17.

Those flow paths 16 and 18 are engraved on the separators in such a manner that the separators have an opening part to the electrolyte membrane side like the separators shown in FIGS. 2A to 2C.

The oxidizer flows toward an outlet 16b from an inlet 16a along the flow path 16, and the fuel solution flows toward an outlet 18b from an inlet 18a along the flow path 18.

In FIG. 4A, the flow path is shown by a dotted line to indicate that the flow path is engraved on the rear side of the oxidizer electrode side separator when viewed in direction A of FIG. 1.

Even when the separators 15 and 17 are used in place of the separators 1 and 4, the present invention can be carried out in the same manner as described above.

When a fuel component contained in the fuel solution diffuses into the oxidizer through the electrolyte membrane, the fuel leaks to the oxidizer side, which reduces both the fuel utilization ratio and the energy conversion efficiency.

Therefore, it is preferred that the electrolyte membrane does not allow fuel to permeate as much as possible.

When an alcohol, such as methanol or ethanol, which is commonly used as a fuel, is used, typically, an output of 80 mW/cm² is obtained in the power generation part. The fuel consumed at this point is approximately 8 to 12 μg/s.

When the alcohol permeability of the electrolyte membrane is 2.0×10⁻⁶ cm²/s, the amount of the alcohol component passing through the electrolyte membrane is approximately 0.4 μg/s/cm² or less.

Therefore, even when a heating/humidifying part having the same area as the power generation part is provided, the amount of the alcohol in the fuel solution, which diffuses to the oxidizer side through the electrolyte membrane in the heating/humidifying part, is 1 to 2% or less of the amount of the fuel that is consumed by the power generation, so that a reduction in the fuel utilization ratio does not become a problem for practical use.

In this embodiment, since the electrolyte membrane of the power generation part 6 and the water-permeable membrane of the heating/humidifying part 7 are constituted of the same member, the structure of the fuel cell is simple, which is preferred from the viewpoint of the reduction in size and production cost of the fuel cell.

### Embodiment 2

A constitutional example of an alkaline fuel cell according to Embodiment 2 of the present invention is described below.

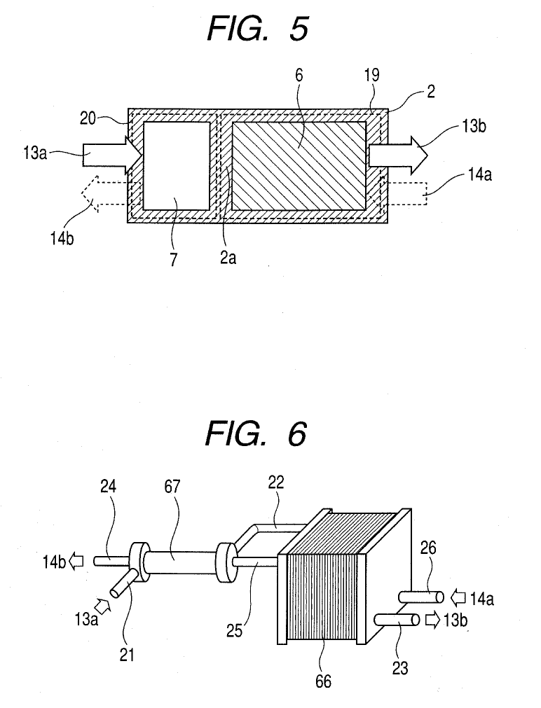

FIG. 5 is a schematic view illustrating the structure of a power generation part and a heating/humidifying part of the alkaline fuel cell of this embodiment.

In FIG. 5, the same constituent elements as those in Embodiment 1 are identified by the same reference numerals and the description of such common parts is omitted.

In Embodiment 1, the power generation part and the heating/humidifying part are constituted of the same electrolyte membrane, while in this embodiment, the electrolyte membrane 19 of the power generation part 6 and the water-permeable membrane 20 of the heating/humidifying part 7 are constituted of different membranes.

Further, as shown in FIG. 5, a sealing part 2a is provided in the gasket 2 in Embodiment 2 for preventing the leakage of an oxidizer gas and a fuel between the power generation part 6 and the heating/humidifying part 7. The rest of the structure is basically the same as that of Embodiment 1.

In the figure, outline arrows 13a and 13b, and dotted arrows 14a and 14b show the flow directions of the oxidizer and the fuel solution, respectively.

The arrows 14a and 14b are depicted by dotted lines to indicate that the fuel solution is supplied to the rear side in a direction perpendicular to the drawing plane of FIG. 5.

The power generation part 6 is constituted by using an MEA having the same configuration as that of Embodiment 1.

Although the structure of the heating/humidifying part 7 is also the same as that of Embodiment 1, the membrane for separating the fuel electrode side space and the oxidizer electrode side space in Embodiment 1 is the electrolyte membrane 3, which is commonly shared by the power generation part. On the contrary, in this embodiment, the membrane is a water-permeable membrane 20, which is provided separately from the electrolyte membrane 19 of the power generation part 6.

In this embodiment, the electrolyte membrane 19 of the power generation part 6 and the water-permeable membrane 20 of the heating/humidifying part 7 can be formed from separate members.

Therefore, the material of the water-permeable membrane 20 of the heating/humidifying part 7 is not limited by the type and thickness of the electrolyte membrane 19 of the power generation part 6, which needs to conduct anions. The material of the water-permeable membrane 20 suitable for the heating/humidifying part 7 can be selected according to the ratio of fuel component permeability to water permeability, the diffusion amount of water, and the like. An aromatic polyimide is an example of a material used for the water-permeable membrane 20. Further, a membrane composed of the same material as that of the electrolyte membrane 19 of the power generation part 6 and having a thickness different from that of the electrolyte membrane 19 may also be used. As described above, by making the water-permeable membrane 20 of the heating/humidifying part 7 different from the electrolyte membrane 19 of the power generation part 6, the characteristics, such as anion conductivity, fuel component permeability, and water permeability, required for each of the membranes can be optimized, and the degree of design freedom can be advantageously enhanced.

### Embodiment 3

A constitutional example of an alkaline fuel cell according to Embodiment 3 of the present invention in which the power generation part and the heating/humidifying part are constituted of separate units is described below.

FIG. 6 is a schematic view illustrating the constitution example of the alkaline fuel cell of this embodiment.

In Embodiments 1 and 2, the power generation part and the heating/humidifying part are paired in the same fuel cell unit. However, in this embodiment, the power generation part and the heating/humidifying part are constituted of separate units. The present invention can be carried out even with such a constitution.

In FIG. 6, the fuel cell has a power generation part 66 having a structure in which a plurality of fuel cell units are stacked, that is, a so-called fuel cell stack structure. Since the constitution of the fuel cell stack is well known, its detailed description is omitted.

The fuel cell has a heating/humidifying part 67 and oxidizer flow paths 21, 22, and 23.

An oxidizer, after passing through the heating/humidifying part 67 in a direction from 13a toward 13b, is supplied into the power generation part 66.

The fuel cell has fuel flow paths for the fuel solution 26, 25, and 24. A fuel solution, after passing through the power generation part 66 in a direction from 14a toward 14b, is supplied into the heating/humidifying part 67. A specific structure of the heating/humidifying part in this embodiment is described below.

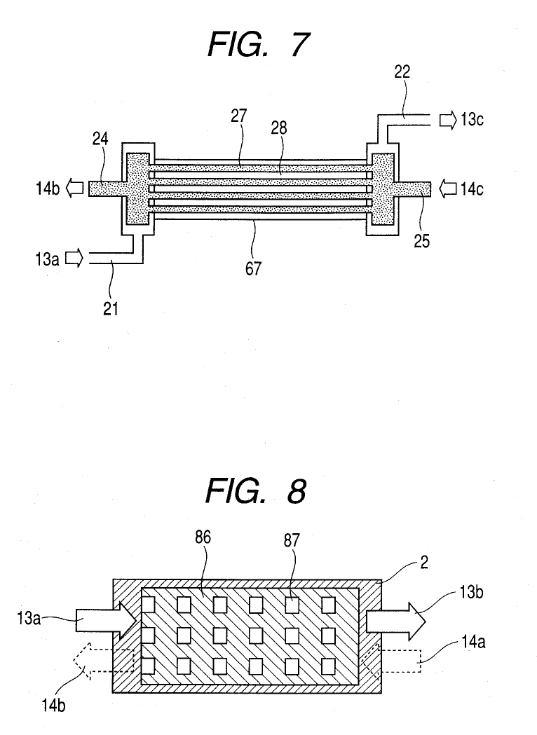

FIG. 7 is a schematic view illustrating the structure of the heating/humidifying part in this embodiment.

In FIG. 7, the fuel cell has tubules 27, each of which is made of a water-permeable membrane and allows the fuel solution to pass therethrough. The water component in the fuel solution passes through the water-permeable membranes and humidifies a gas in the space 28 inside the heating/humidifying part 67.

The fuel solution, which passed through the power generation part 66, is supplied into the heating/humidifying part 67 through the fuel flow path 25 (in the direction indicated by outline arrow 14c) is divided into the tubules 27 to pass through the heating/humidifying part 67, and is discharged from the fuel flow path 24 (in the direction indicated by outline arrow 14b).

The oxidizer is supplied into the heating/humidifying part 67 from the oxidizer flow path 21 (in the direction indicated by outline arrow 13a) passes through the space 28 inside the heating/humidifying part and then through the oxidizer flow path 22 (in the direction indicated by outline arrow 13c), and is supplied into the power generation part 66. In the heating/humidifying part 67, the oxidizer passing through the space 28 is heated corresponding to the temperature of the fuel solution passing through the tubules 27 and humidified with the water component of the fuel solution from the surfaces of the tubules 27.

Also, in this embodiment, as in Embodiment 1, since the oxidizer is heated and humidified by the fuel solution that passed through the power generation part 66, the oxidizer can be humidified under conditions corresponding to the temperature of the power generation part 66.

Moreover, since water is generated in the fuel solution by the power generation reaction and is used to humidify the oxidizer, the amount of water additionally supplied to the fuel solution for oxidizer humidification can be reduced as much as possible.

In this embodiment, because the heating/humidifying part and the power generation part are constituted of separate units, the amount of humidification, the pressure loss in the oxidizer flow path, and the three-dimensional shapes of the power generation part and the heating/humidifying part can be designed flexibly according to intended purposes.

### Embodiment 4

A constitutional example of an alkaline fuel cell according to Embodiment 4 of the present invention in which a heating/humidifying part is disposed in a dispersed manner in a power generation part is described below.

FIG. 8 is a schematic view illustrating the power generation part and the heating/humidifying parts in this embodiment.

In FIG. 8, the same constituent elements as those in Embodiment 1 are identified by the same reference numerals and the description of such common parts is omitted.

In FIG. 8, the fuel cell has a power generation part 86 and a heating/humidifying part 87.

The constitution of this embodiment is basically the same as that of the fuel cell of Embodiment 1, except that the heating/humidifying parts 87 are disposed dispersedly in the power generation part 86.

In the figure, outline arrows 13a and 13b, and dotted arrows 14a and 14b show the flow directions of the oxidizer and the fuel solution, respectively.

The arrows 14a and 14b are depicted by dotted lines to indicate that the fuel solution is supplied to the rear side in a direction perpendicular to the drawing plane of FIG. 8.

In Embodiment 1, the power generation part and the heating/humidifying part are provided separately in two regions, that is, on the downstream side of the oxidizer flow (the upstream side of the fuel solution flow) and on the upstream side of the oxidizer flow (the downstream side of the fuel solution flow) on a single electrolyte membrane.

On the contrary, in this embodiment, as shown in FIG. 8, instead of the configuration in which the power generation part and the heating/humidifying part are separated from each other, a configuration is employed in which the heating/humidifying part is disposed dispersedly in the power generation part.

The structure of the power generation part 86 is the same as that of the MEA in Embodiment 1, except that the heating/humidifying part is disposed in a dispersed manner in the power generation part.

Further, in this embodiment, although the heating/humidifying parts 87 has a structure in which the oxidizer side and the fuel solution side is simply partitioned with the electrolyte membrane as is the case in Embodiment 1, the heating/humidifying part is disposed in a dispersed manner in the power generation part, as shown in FIG. 8.

In this case, when the heating/humidifying part is disposed dispersedly such that the proportion of the power generation part per unit area of the electrolyte membrane increases as the oxidizer flows in the oxidizer flow path (the proportion of the heating/humidifying part decreases), the oxidizer is uniformly humidified, which is effective.

In this embodiment, since the temperatures of the oxidizer and the fuel solution are maintained at almost the same level at the heating/humidifying part 87 and the power generation part 86, the humidification of the oxidizer can be carried out at a more preferred temperature, which is advantageous. The heating/humidifying part in the power generation part can have any shape, including square, rectangular, and circular shapes.

### EXAMPLES

Examples of the present invention are described below.

### Example 1

In this example, an oxidizer electrode obtained by applying a catalyst carrying iron and cobalt on carbon fine particle to the surface of carbon paper and a fuel electrode obtained by applying a catalyst carrying nickel, cobalt, and iron on carbon fine particle to the surface of nickel foam were used. When applying the catalysts, polytetrafluoroethylene was used as a binder.

Further, an electrolyte membrane was interposed between the electrodes.

Moreover, a fuel cell unit was produced by sandwiching the resulting stack with carbon current collectors having a flow path from outside of the electrodes.

At that time, a half of the electrolyte membrane was covered with the catalysts of the oxidizer electrode and the fuel electrode so as to serve as a power generation part. The other half was not covered with the catalysts so as to serve as a heating/humidifying part.

The assembling was conducted such that the heating/humidifying part was located on the oxidizer inlet side of the oxidizer flow path and the power generation part was located on the oxidizer outlet side. The power generation part was located on the fuel inlet side of the fuel flow path. The heating/humidifying part was located on the fuel outlet side.

Dry air as the oxidizer was supplied at a flow rate of 0.2 l/min into the oxidizer flow path of the thus produced fuel cell such that the air passed through the heating/humidifying part and then reached the power generation part.

A 10% ethanol, 1M KOH aqueous solution was supplied as the fuel at a flow rate of 2 ml/min into the fuel flow path such that the solution passed through the power generation part and then reached the heating/humidifying part.

The output of the fuel cell was measured while the load current was increased at a rate of 50 mA/cm²/min. At this time, the temperature of the power generation part was 70° C.

### Comparative Example 1

As Comparative Example 1, a fuel cell unit produced by following the same procedure as in Example 1 was used. Dry air was supplied as the oxidizer at a flow rate of 0.2 l/min into the oxidizer flow path such that the air passed through the power generation part and then reached the heating/humidifying part.

Further, a 10% ethanol, 1M KOH aqueous solution was supplied as the fuel at a flow rate of 2 ml/min into the fuel flow path such that the solution passed through the heating/humidifying part and then reached the power generation part.

Thus, the supply (or flow) directions of the oxidizer and the fuel solution in Embodiment 1 were reversed and the output of the fuel cell was measured while the load current was increased at a rate of 50 mA/cm²/min. The temperature of the power generation part was 70° C. as in Example 1.

Table 1 below shows the maximum output values in Example 1 and Comparative Example 1 measured as described above and normalized with the maximum output value of Example 1 set to 1.

TABLE 1

| Example/Comparative Example | Normalized Maximum |
|---|---|
| Number | Output Value |
| Example 1 | 1 |
| Comparative | 0.86 |
| Example 1 | |

It can be seen from the results that the present invention provided an increased output.

Even when the procedures of Example 1 and Comparative Example 1 were followed, respectively, with the exception that air fully humidified at room temperature was used as the oxidizer in place of dry air in Example 1 and Comparative Example 1, the same results as in Table 1 were obtained.

It is assumed that since the temperature of the power generation part was 70° C., which was higher than room temperature, the oxidizer humidified at room temperature had a low relative humidity in the power generation part, whereby the same results as those with the oxidizer not humidified at room temperature were obtained.

### Example 2

As Example 2, a fuel cell unit produced by following the same procedure as in Example 1 was used, the temperature of the power generation part was maintained at 70° C., and an oxidizer with the humidity that was adjusted to 10% at 70° C. was supplied to the fuel cell. The output of the fuel cell was measured.

### Comparative Example 2

As Comparative Example 2, the procedure of Example 2 was followed, except that the supply (or flow) directions of the oxidizer and the fuel solution were reversed, that is, such that the oxidizer was supplied into the heating/humidifying part after passing through the power generation part, and the fuel solution was supplied into the power generation part after passing through the heating/humidifying part. The output of the fuel cell was measured in a similar manner.

### Comparative Example 3

The procedure of Comparative Example 2 was followed, except that the humidity of the oxidizer was changed to 26% at 70° C. (temperature of the power generation part). The output of the fuel cell was measured.

### Comparative Example 4

The procedure of Comparative Example 2 was followed, except that the humidity of the oxidizer was changed to 66% at 70° C. (temperature of the power generation part). The output of the fuel cell was measured.

Table 2 below shows the maximum output values measured as described above and normalized with the maximum output value of Example 2 set to 1.

TABLE 2

| Example/Comparative Example | Normalized Maximum |
|---|---|
| Number | Output Value |
| Example 2 | 1 |
| Comparative Example 2 | 0.85 |
| Comparative Example 3 | 0.90 |
| Comparative Example 4 | 0.92 |

It can be seen from the results of Comparative Examples 2, 3, and 4 that the improvement of the output is seen as the humidity of the oxidizer increases.

It can be assumed from this that the output is lower in Comparative Example 2 than in the other examples because of insufficient humidity of the oxidizer.

That is, it can be seen that by employing the present invention, a humidified oxidizer can be supplied to an oxidizer electrode, thereby improving the output of a fuel cell.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-168570, filed Jun. 27, 2007, which is hereby incorporated by reference herein in its entirety.

What is claimed is:

1. An alkaline fuel cell comprising:
a power generation part having an anion exchange membrane disposed between a fuel electrode to which a fuel solution containing a fuel component and a water component is supplied and an oxidizer electrode to which an oxidizer is supplied; and
a heating/humidifying part for heating and humidifying the oxidizer to be supplied to the oxidizer electrode,
wherein the heating/humidifying part has a water permeable membrane for separating the oxidizer and the fuel solution such that heat and a water component of the fuel solution are transportable to the oxidizer through the water permeable membrane.

2. The alkaline fuel cell according to claim 1, further comprising a separator which has an oxidizer flow path for supplying the oxidizer to the power generation part and is provided on an oxidizer electrode side and a separator which has a fuel flow path for flowing the fuel solution and is provided on a fuel electrode side, wherein the power generation part and the heating/humidifying part are interposed between the separators.

3. The alkaline fuel cell according to claim 2, wherein the anion exchange membrane of the power generation part and the water permeable membrane of the heating/humidifying part are the same member.

4. The alkaline fuel cell according to claim 2, wherein the anion exchange membrane of the power generation part and the water permeable membrane of the heating/humidifying part are different members.

5. The alkaline fuel cell according to claim 3, wherein the heating/humidifying part is provided upstream of the power generation part with respect to a flow of the oxidizer.

6. The alkaline fuel cell according to claim 3, wherein the heating/humidifying part is disposed in a dispersed manner in the power generation part.

7. The alkaline fuel cell according to claim 1, wherein the heating/humidifying part constitutes a unit which is separate from the power generation part and is provided upstream of the power generation part with respect to a flow of the oxidizer, and the heating/humidifying part unit has a fuel flow path at least a part of which is formed a water permeable membrane, and an oxidizer flow path for supplying the oxidizer to the power generation part.

8. The alkaline fuel cell according to claim 1, wherein the fuel component is an alcohol or an ether.

9. The alkaline fuel cell according to claim 8, wherein the fuel component is ethanol or methanol.

10. The alkaline fuel cell according to claim 9, wherein the alcohol permeability of the anion exchange membrane for ethanol or methanol is 2.0×10⁻⁶ cm²/s or less.
